(19) United States
(12) Patent Application Publication
(10) Pub. No.: US 2006/0288336 A1
(43) Pub. Date: Dec. 21, 2006

(54) Module initialization

(75) Inventors: Sean E. Trowbridge, Sammamish, WA (US); Michael Rayhelson, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/188,428

(22) Filed: Jul. 25, 2005

Related U.S. Application Data
(60) Provisional application No. 60/692,666, filed on Jun. 21, 2005.

(51) Int. Cl. G06F 9/44

(52) U.S. Cl. 717/130

(57) ABSTRACT

Dependencies among code modules loaded into a particular execution environment may be graphed, charted, or otherwise listed. Thus, when one of the code modules is initialized within one or more isolated execution constructs of the execution environment, other code modules that are graphed, charted, or otherwise listed as having a dependency from the initialized code module are initialized in the same isolated execution constructs.

### RELATED APPLICATIONS

This application claims priority benefit of U.S. Provisional Patent Application No. 60/692,666, filed on Jun. 21, 2005, by one or more of the present inventors and assigned to Microsoft Corporation, the assignee of the present application.

### BACKGROUND

Assemblies may include code that is divided into modules (hereafter referred to as “code modules”), and such code modules may be independently generated and loaded into an execution environment. Upon being loaded into the execution environment, individually generated code modules may become interrelated or such an existing interrelationship may be otherwise revealed. Binding between the code modules may include methods, instantiated types, inherent form types, etc.

One or more of such code modules loaded into a managed execution environment may have initialization code that is to be run or executed prior to running or executing any other code that is associated with the code module, for example, as a matter of contract. Examples of such initialization code may be used to initialize state or run a security check for an executable portion of the code associated with the code module.

Code that may be used to execute code associated with one or more of the code modules may be shared across multiple isolation constructs for executing a process within an execution environment, and code associated with one code module may call into code associated with another code module. Secure and efficient code execution calls for the initialization code to be run individually for each code module in each of the isolation constructs.

### SUMMARY

Module initialization among shared code is described herein.

When multiple code modules are loaded into an execution environment, dependencies among at least some of the code modules may be graphed, charted, or otherwise listed. When any one of the code modules is initialized within one or more isolated execution constructs, other code modules that are graphed, charted, or otherwise listed as having a dependency from the initialized code module are initialized in the same isolated execution constructs. Such initialization is performed typically, though not exclusively, before any code associated with the code module may be executed, subject to reentrancy constraints.

### DESCRIPTION OF THE DRAWINGS

Module initialization in shared code is presently described in accordance with the following figures.

FIG. 1 shows devices communicating over a network, with the devices implementing example technologies for module initialization.

FIG. 2 shows an example of an execution environment for implementing example technologies for module initialization.

FIG. 3 shows an example data flow in accordance with an example implementation of module initialization.

FIG. 4 shows an example proce ssing flow in accordance with an example implementation of module initialization.

FIG. 5 shows another example processing flow in further accordance with an example implementation of module initialization.

### DETAILED DESCRIPTION

Module initialization in shared code is described herein.

More particularly, module initialization in shared code may relate to efficient module transitions within one or more isolation constructs for executing a process. Further, module initialization may be implemented in one or more devices, or nodes, in a network environment.

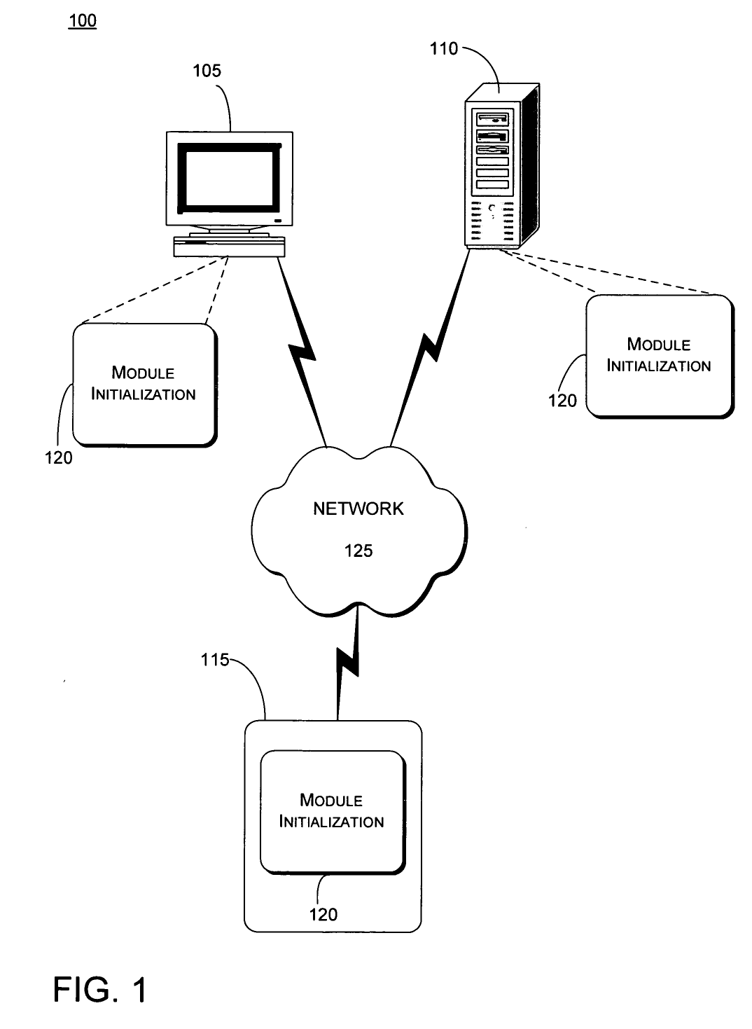

FIG. 1 shows example network environment 100 in which example technologies for module initialization may be implemented, although module initialization is not limited to network environments. In FIG. 1, client device 105, server device 110, and “other” device 115 may be communicatively coupled to one another via network 125; and, further, at least one of client device 105, server device 110, and “other” device 115 may be capable of implementing module initialization 120, as described herein.

Client device 105 may represent at least one of a variety of conventional computing devices, including a desktop personal computer (PC), workstation, mainframe computer, Internet appliance, set-top box, and gaming console. Client device 105 may further represent at least one of any device that is capable of being associated with network 125 by a wired and/or wireless link, including a mobile (i.e., cellular) telephone, personal digital assistant (PDA), laptop computer, etc. Further still, client device 105 may represent the client devices described above in various quantities and/or combinations thereof. “Other” device 115 may also be embodied by any of the above examples of client device 105.

Server device 110 may represent any device that is capable of providing any of a variety of data and/or functionality to client device 105 or “other” device 115 in accordance with at least one implementation of module initialization 120. The data may be publicly available or alternatively restricted, e.g., restricted to only certain users or only if an appropriate subscription or licensing fee is paid. Server device 110 may be at least one of a network server, an application server, a blade server, or any combination thereof. Typically, server device 110 may represent any device that may be a content source, and client device 105 may represent any device that may receive such content either via network 125 or in an off-line manner. However, according to the example implementations described herein, client device 105 and server device 110 may interchangeably be a sending node or a receiving node in network environment 100. “Other” device 115 may also be embodied by any of the above examples of server device 110.

“Other” device 115 may represent any further device that is capable of implementing module initialization 120 according to one or more of the examples described herein. That is, “other” device 115 may represent any software-enabled computing or processing device that is capable of implementing module initialization for an application, program, function, or other assemblage of programmable and executable code in at least a managed execution environment. Thus, “other” device 115 may be a computing or processing device having at least one of an operating system, an interpreter, converter, compiler, or runtime execution environment implemented thereon. These examples are not intended to be limiting in any way, and therefore should not be construed in that manner.

Network 125 may represent any of a variety of conventional network topologies and types, which may include wired and/or wireless networks. Network 125 may further utilize any of a variety of conventional network protocols, including public and/or proprietary protocols. Network 125 may include, for example, the Internet as well at least portions of one or more local area networks (also referred to, individually, as a “LAN”), such as 802.11 system or, on a larger scale, a wide area network (i.e., WAN”); or a personal area network (ie., PAN), such as Bluetooth.

Computer architecture in at least one of devices 105, 110, and 115 has typically been defined computing platforms in terms of hardware and software. Software for computing devices has been categorized into groups, based on function, which may include: a hardware abstraction layer (alternatively referred to as a “HAL”), an operating system (alternatively referred to as “OS”), and applications.

A runtime execution environment may refer to an isolated space, between an OS and an application, in which the application may execute specific tasks on at least one of processing device 105, 110, or 115. More particularly, a runtime execution environment may enhance the reliability of the execution of applications on a growing range of processing devices 105, 110, and 105, including servers, desktop computers, laptop computers, and mobile processing devices by providing a layer of abstraction and services for an application running on such processing devices, and further providing the application with capabilities including memory management and configuration thereof.

A runtime execution environment may serve as at least one of an application programming and application execution platform. As an application programming platform, a runtime execution environment may compile targeted applications, which may be written in one of multiple computing languages, into an intermediate language (hereafter “IL”). IL is typically independent of the platform and the central processing unit (hereafter “CPU”) executes IL. In fact, IL is a higher level language than many CPU machine languages. As an application execution platform, a runtime execution environment may interpret compiled IL into native machine instructions. A runtime execution environment may utilize either an interpreter or a compiler (e.g., “just-in-time,” alternatively “JIT,” compiler) to execute such instructions. Regardless, the native machine instructions may then be directly executed by the CPU. Since IL is CPU-independent, IL may execute on any CPU platform as long as the OS running on that CPU platform hosts an appropriate runtime execution environment. Examples of runtime environments, to which module initialization 120 may pertain, include: Visual Basic runtime environment; Java® Virtual Machine runtime environment that is used to run, e.g., Java® routines; or Common Language Runtime (CLR) to compile, e.g., Microsoft .NET™ applications into machine language before executing a calling routine. However, this listing of runtime environments provides examples only. The example implementations are not limited to just these managed execution environments. More particularly, the example implementations are not just limited to managed execution environments, for one or more examples may be implemented within testing environments and/or unmanaged execution environments.

An application compiled into IL may be referred to as “managed code,” and therefore a runtime execution environment may be alternatively referred to as a “managed execution environment.” Code that does not utilize a runtime execution environment to execute may be referred to as native code applications.

In at least one managed execution environment, a unit of isolation or “isolation construct” for a process may be referred to as an application domain. Such terminology is provided as an example only. That is, the example implementations described herein are not limited to application domains or even to managed execution environments, but rather may be applied within various other isolation construct implementations in various execution environments.

Isolation constructs such as application domains may enable code that is to be executed therein to be loaded from a specified source; code execution within an isolation construct may be aborted independent of code execution in other such isolation constructs; and code execution within an isolation construct may be isolated so that a fault occurring therein does not affect code execution in other isolation constructs within the process. In other words, the effects of code execution within an isolation construct are not visible to concurrently-running constructs until the overall process is made permanent. For the sake of consistency, the discussion hereafter may refer to “applications” and “processes,” both of which may encompass any one of, at least, software programs, and applications, either singularly or in combination.

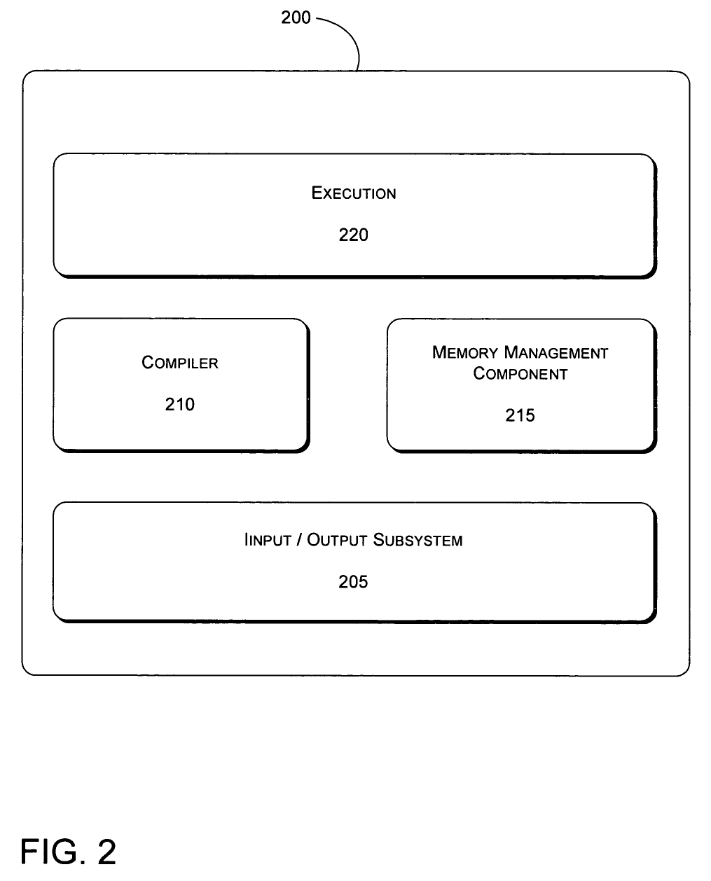

FIG. 2 shows an example of runtime execution environment 200 in which examples of application domains and, more particularly, module initialization 120 (see FIG. 1) may be implemented.

According to at least one example implementation, runtime execution environment 200 may facilitate execution of managed code for a computing device platform. Managed code may be considered to be part of a core set of application-development technologies, and may further be regarded as an application, program, function, or other assemblage of programmable and executable code that is compiled for execution in runtime execution environment 200 to provide a corresponding service to the computing device platform. In addition, runtime execution environment 200 may translate managed code at an interpretive level into instructions that may be proxied and then executed by a processor. A framework for runtime execution environment 200 also provides class libraries, which may be regarded as software building blocks for managed applications.

Runtime execution environment 200 may provide at least partial functionality that may otherwise be expected from a kernel, which may or may not be lacking from a computing device platform depending upon resource constraints for the particular one of devices 105, 110, and 115 (see FIG. 1). Thus, at least one example of runtime execution environment 200 may implement the following: input/output (hereafter “I/O”) routine management, memory management, compiling, and service routine management. Thus, runtime execution environment 200 may include I/O component 205, compiler 210, at least one memory management component 215, and execution component 220. These components, which are to be described in further detail below, are provided as examples, which are not intended to be limiting to any particular implementation of runtime execution environment 200, and no such inference should be made. Thus, the components may be implemented in examples of runtime execution environment 200 in various combinations and configurations thereof.

I/O component 205 of runtime execution environment 200 may provide asynchronous access to data sources (i.e., processor and peripherals) associated with the computing device platform. More particularly, I/O component 205 may provide runtime execution environment 200 with robust system throughput and further streamline performance of code from which an I/O request originates.

Compiler 210 may refer to a module within runtime execution environment 200 that may interpret compiled IL into native machine instructions for execution in runtime execution environment 200. Further, in accordance with at least one example implementation of module initialization 120, compiler 210 may dynamically analyze the behavior of code modules associated with an application, program, function, or other assemblage of programmable and executable code that may be loaded into runtime execution environment 200. Further still, the analysis may be performed without touching or affecting an executable portion of the code modules. The analysis may be performed at compile time, initial runtime, or at any time thereafter during execution of an executable portion of the code modules in their respective isolation constructs. Even further, the aforementioned analysis of the code modules may be accomplished by graphing, charting, or otherwise listing dependencies among even portions of code modules associated with an application loaded into runtime execution environment 200. Such dependencies among code modules may, according to one or more implementations of module initialization 120, alternatively be referred to as “active dependencies.”

Determinations of active dependencies among code modules loaded into runtime execution environment 200 may be made by compiler 210. However, such implementations are exemplary only. One or more alternative implementations may contemplate such determinations being made within runtime execution environment 200 by, e.g., a loader or an administrative component that is capable of analyzing calls from one code module to another. Even further alternative implementations may contemplate such determinations being made by a component that is external to runtime execution environment 200 prior to, simultaneous with, or after the code modules are loaded into runtime execution environment 200. Further still, active dependencies may be explicitly called out in respective code modules. Therefore, the example of FIG. 2 should not be interpreted as limiting in any manner.

Memory management component 215 may be regarded as a “garbage collector.” Garbage collection may be regarded as a robust feature of managed code execution environments by which an object is automatically freed (i.e., de-allocated) if an object is no longer used by any applications, upon a sweep or scan of a memory heap. Further functions implemented by memory management component 215 may include: managing one or more contiguous blocks of finite volatile RAM (i.e., memory heap) storage or a set of contiguous blocks of memory amongst the tasks running on the computing device platform; allocating memory to at least one application running on the computing device platform; freeing at least portions of memory on request by at least one of the applications; and preventing any of the applications from intrusively accessing memory space that has been allocated to any of the other applications.

Execution component 220 may enable execution of managed code for the computing device platform. More particularly, with regard to module initialization implementation 120, execution component 220 may serve as an exemplary component within runtime execution environment 200 that may initialize (i.e., activate) code modules, within respective isolation constructs, that are determined to be actively dependent upon each other. Put yet another way, execution component 220 may serve as an exemplary component to enforce a constraint on one or more code modules, in any isolation construct that a first module is initialized, for which an active dependency from a first code module has been graphed, charted, or otherwise listed.

Such initialization, according to generalized view of module initialization 120, provides, at least, that, when execution component 220 initializes a first code module in a new isolation construct, execution component 220 is to further initialize any other code module that has been determined to have an active dependency from that first module before other code associated with the first code module is executed, subject to, e.g., reentrancy constraints. Alternatively, the aforementioned initialization may provide that, when a new active dependency is detected from the first code module to another code module, execution component 220 is to initialize the other code module in every isolation construct in which the first code module has been initialized, also before executable code associated with the first code module is executed.

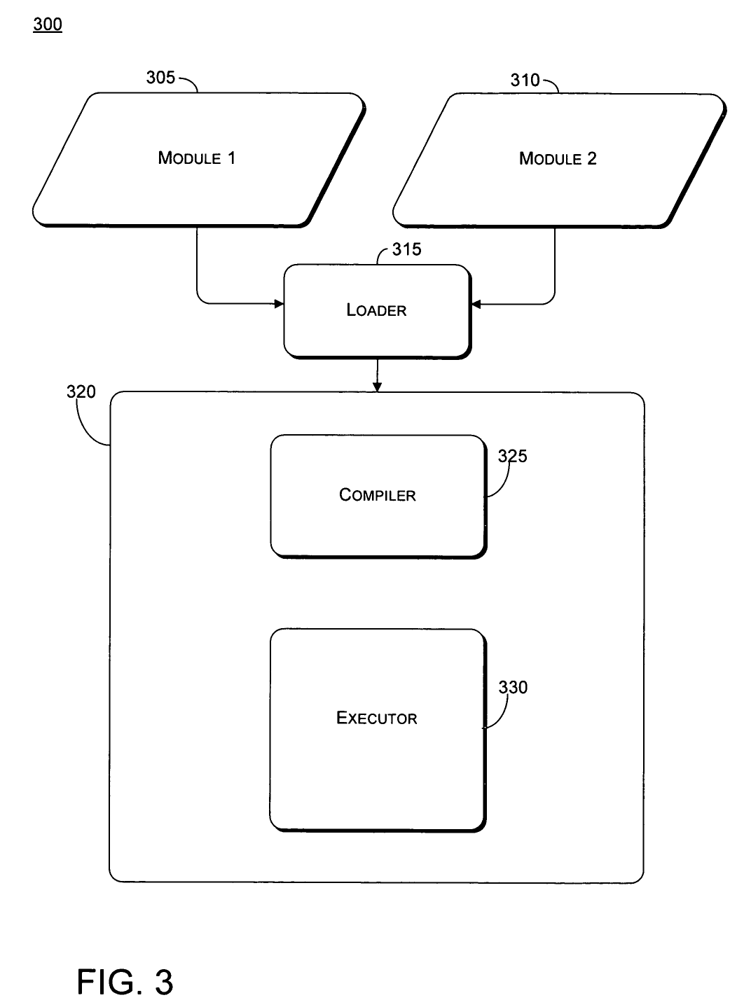

FIG. 3 shows example data flow 300 in accordance with an example implementation of module initialization 120 (see FIG. 1). The description of data flow 300 refers to runtime execution environment 320. However, runtime execution environment 320 and associated components may be attributed with at least the same features and characteristics described above with regard to runtime execution environment 200 described with regard to FIG. 2.

Module 1 305 and module 2 310 may represent at least a portion of an application, program, function, or other assemblage of programmable and executable code to be loaded into runtime execution environment 320. Module 1 305 and module 2 310 may or may not be independently generated. Further, according to at least one implementation of module initialization 120, an interrelationship between module 1 305 and module 2 310 may or may not exist prior to loading into runtime execution environment 320. Any such interrelationship may be revealed subsequent to loading.

Loader 315 may refer to an assembly manager that may be invoked to locate and read at least portions of code modules as needed. Thus, loader 315 may garner module 1 305 and module 2 310 for loading into runtime execution environment 200 serving, in effect, as the entry point to the runtime execution environment 320. Such loading of code modules is typically performed singularly (ie., on a module-by-module basis), though alternative implementations may contemplate code modules being loaded collectively. Further, loader 315 may be disposed in an unmanaged execution environment (ie., OS), although alternative implementations of runtime execution environment 320 may include loader 315 therein.

Compiler 325 may receive module 1 305 and module 2 310 from loader 315. Compiler 325 may dynamically analyze the behavior of module 1 305 and module 2 310, and graph, chart, or otherwise list dependencies among even portions of module 1 305 and module 2 310. More particularly, compiler 325 may determine the existence of any active dependencies that may exist between module 1 305 and module 2 310, as well as any other code module that may be further loaded into runtime execution environment 320. Alternatively, active dependencies may be explicitly declared by code associated with a respective code module.

Compiler 325 may determine that an active dependency from module 1 305 to at least module 2 310 may exist when any combination of two or more of at least the following conditions exist: at least a portion of code associated with module 1 305 is to run or in-line at least a portion of code associated with module 2 310; at least a portion of code associated with module 1 305 is to access one or more static, global, or instance variables of a type declared by at least a portion of code associated with module 2 310; or for at least a portion of code associated with module 1 305, any of the above operations is to be performed on a generic type with a type parameter that is associated with module 2 310 or derived from a type associated with module 2 310. Again, such determinations of active dependencies among code modules loaded into runtime execution environment 320 are exemplary only and, further, active dependencies may be explicitly declared by code associated with a respective code module.

Executor 330 may serve to initialize or activate, within respective isolation constructs, module 1 305 and module 2 310 among which active dependencies are determined to exist by compiler 325. More particularly, when executor 330 initializes module 1 305 in one or more isolation constructs, execution component 330 is to further initialize module 2 310, as well as any other code module that has been determined to have an active dependency from module 1 305, in those same isolation constructs. Moreover, such initializations are to occur before executable portions of code associated with the module 1 305 are executed, subject to reentrancy constraints.

Alternatively, the aforementioned initialization or activation may provide that, when compiler 325 detects a new active dependency from module 1 305 to another code module loaded into runtime execution environment 320, execution component 330 is to initialize or activate the newly loaded code module in every isolation construct in which module 1 305 has been initialized or activated, also subject to reentrancy constraints. Such initialization of a code module, having an active dependency from code module 1 305, may be referred to as an active transition.

To provide efficient active transitions from one code module to another code module across isolation construct boundaries, executor 330 may implement the aforementioned initialization or activation at the occurrence of any combination of one or more of at least the following: at least a portion of code associated with module 1 305 calling or in-lining a method of a type declared by at least a portion of code associated with module 2 310; at least a portion of code associated with module 1 305 accessing a static, global or instance variable of a type declared by at least a portion of code associated with module 2 310; at least a portion of code associated with module 1 305 allocating an instance of a type declared by at least a portion of code associated with module 2 310 or of a type derived from at least a portion of code associated with module 2 310; or for at least a portion of code associated with module 1 305, any of the above operations executing on a generic type with a type parameter that is associated with module 2 310 or derived from a type associated with module 2 310.

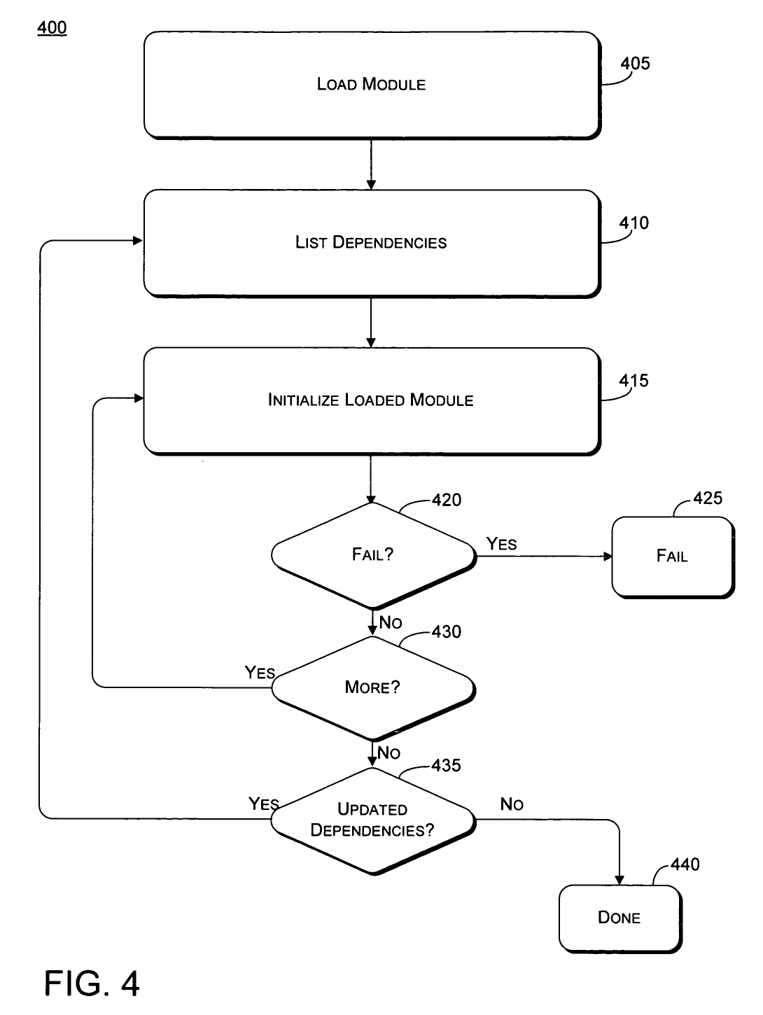

FIG. 4 shows example processing flow 400 in accordance with an example implementation of module initialization 120 (see FIG. 1). Processing flow 400 may be described with reference to features described previously with regard to FIGS. 2 and 3. Such features are provided by example only, and are not intended to be limiting in any manner.

Block 405 may refer to loader 315 loading at least module 1 305 and module 2 310 into runtime execution environment 320, either individually or collectively as described above. Further, as described previously, loader 315 may be disposed in an unmanaged execution environment (i.e., OS), although at least one example of runtime execution environment 320 may include loader 315 therein.

Block 410 may refer to compiler 325 compiling module 1 305 310 to, among other functions, analyze the behavior of code associated with at least module 1 305 and module 2 310. Such analysis is performed for compiler 325 to graph, chart, or otherwise list dependencies among the code associated with at least module 1 305, module 2 310, and other loaded code modules. More particularly, compiler 325 may determine the existence of an active dependency from code associated with module 1 305 to code associated with at least module 2 310 if, upon compilation, any combination of two or more of the following example conditions exist: at least a portion of code associated with module 1 305 is to run or in-line at least a portion of code associated with module 2 310; at least a portion of code associated with module 1 305 is to access one or more static, global, or instance variables of a type declared by at least a portion of code associated with module 2 310; at least a portion of code associated with module 1 305 is to allocate an instance of a type found in at least a portion of code associated with module 2 310, or at least a portion of code associated with module 1 305 is to execute any of the above operations on a generic type with a type parameter that is associated with module 2 310 or derived from a type associated with module 2 310. However, such determinations of active dependencies among code modules loaded into runtime execution environment 320 are exemplary only, and are therefore not limiting.

Block 415 may refer to executor 330 initializing or activating at least a portion of code associated with module 1 305 in at least one isolation construct for execution (e.g., application domain). Such isolation constructs may enable the initialized or activated code to be both executed and aborted independent of code being executed or aborted in other such isolation constructs, so that a fault occurring within one isolate construct does not affect processing within another isolation construct.

Decision 420 may refer to executor 330 determining whether the initialization or activation at block 415 has failed. That is, because initialization of code module 1 305 may fail for a particular isolation construct, safe and efficient active transition implementations may contemplate an active transition from code module 1 305 to code module 2 310 failing for certain isolation constructs (i.e., the isolation constructs with the initialization failure) but succeed for other isolation constructs.

Block 425, upon positive decision 420, may refer to executor 330 implementing a failure model for safe and efficient module initialization that may include performing a runtime check that accesses per-domain state to determine for which isolation constructs initialization of code module 1 305 should fail. However, such model may be expensive in terms of required resources.

Therefore, block 425 may alternatively refer to a failure model that includes generating a “trigger,” as opposed to the runtime check, which is a codegen pattern which may be tripped by, e.g., loader 315 or compiler 325 upon an initialization failure in runtime execution environment 320. The trigger may then initiate the aforementioned runtime check, although on a much less frequent (and therefore less expensive) basis.

In view of the foregoing description of the runtime check and trigger, an alternative implementation of decision 420 may include a determination as to whether a runtime check is to be executed, as indicated by code associated with a particular code module or turned on by a trigger. The absence of such a runtime check may result in processing flow 400 proceeding to a failure model at block 425, and the presence of such a runtime check may result in processing flow 400 proceeding to decision 430.

An even further alternative model failure may include a complete failure of processing flow 400.

Decision 430, upon negative decision 420, may refer to compiler 325 determining whether code associated with module 1 305, or a subsequently loaded code module, has further active dependencies to code associated with other code modules.

Positive decision 430 directs processing flow 400 back to block 415, where, as described above, the further code modules to which module 1 305 has an active dependency, may be initialized.

Decision 435, upon negative decision 430, may refer to compiler 325 re-compiling code loaded into execution environment 320, in effect updating the analysis of code modules loaded into runtime execution environment 320. Thus, active dependencies for both module 1 305, module 2 310, and any other loaded code module may be updated.

Block 440, subsequent to negative decision 435, may refer to executor 330 executing executable code associated with the code modules that have been initialized or activated in one or more isolation constructs. Since initialization code is to be run or executed prior to running or executing an executable portion of code that is associated with a corresponding code module, an executable portion of the code associated with the code module is not executed until initialization for each actively dependent code module is complete within a respective isolation construct, subject to reentrancy constraints.

Subsequent to positive decision 435, executor 330 may direct processing flow 400 back to block 410. More particularly, when compiler 325 detects a new active dependency from a code module to another code module loaded into runtime execution environment 320, compiler 325 is to, among other functions, analyze the behavior of code associated with the respective loaded code modules in order to graph, chart, or otherwise list dependencies among the code associated with the respective code modules, as described above.

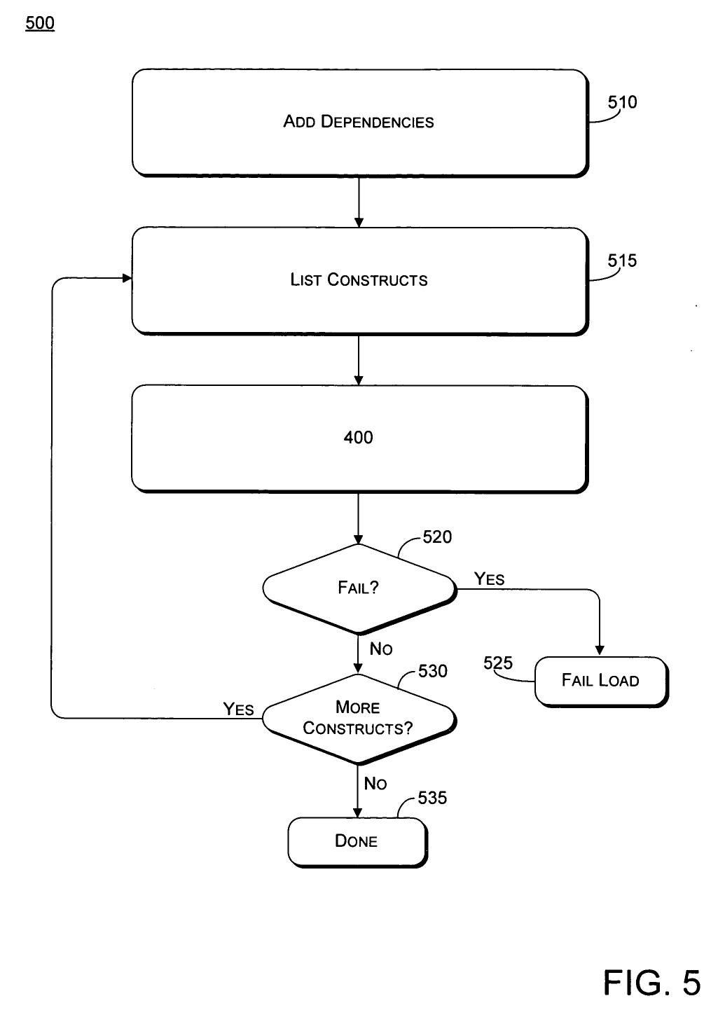

FIG. 5 shows example processing flow 500 in further accordance with an example implementation of module initialization 120 (see FIG. 1). More particularly, processing flow 500 may be implemented by compiler 325 as a set of operations that occur substantially simultaneously with processing flow 400 (see FIG. 4), which may be implemented by, e.g., compiler 325 in cooperation with executor 330. Therefore, processing flow 500 may be described with reference to features described previously with regard to FIGS. 2-4. Such features are provided by example only, however, and are not intended to be limiting in any manner.

Block 510 may refer to compiler 325 analyzing the behavior of code associated with a previously loaded code module to determine if the previously loaded code modules have any additional active dependencies to the additional code modules. As set forth above, the loading of module 1 305, module 2 310, or any other code module, may be performed individually rather than collectively.

Block 515 may refer to compiler 325 listing isolated execution constructs (e.g., application domains) in which, at least, module 1 205 is loaded code.

Block 400 may refer to processing flow 400 being implemented for the code modules analyzed at block 510 with regard to the respective isolation constructs listed at block 510.

Decision 520 may refer to compiler 325 determining whether a failure has occurred in processing flow 400, as at decision 420 (see FIG. 4).

Block 525, upon positive decision 520, may refer to compiler 325 implementing a failure model for loading a code module into a current isolation construct corresponding to one of the alternative failure models described above with regard to block 425 (see FIG. 4).

Decision 530, upon negative decision 520, may refer to compiler 325 determining whether there exist one or more isolation constructs into which any of the currently loaded code modules are to be initialized.

Upon positive decision 530, processing flow 500 may be directed back to block 515, where compiler 325 may list further isolation prior to further implementation of processing flow 400.

Block 535, upon negative decision 520, may refer to code module initialization, as implemented in accordance with processing flow 500, coming to an end.

By the description above, pertaining to FIGS. 1-5, module initialization for a runtime execution environment may be configured in accordance with data associated with executable code loaded therein. However, the example implementations described herein are not limited to just the environment of FIG. 1, the components of FIGS. 2 and 3, or the process of FIGS. 4 and 5. Module initialization 120 (see FIG. 1) may be implemented by various combinations of the components described with reference to FIGS. 2 and 3, as well as in various orders of the blocks described with reference to FIGS. 4 and 5.

Further, the computer environment for any of the examples and implementations described above may include a computing device having, for example, one or more processors or processing units, a system memory, and a system bus to couple various system components.

The computing device may include a variety of computer readable media, including both volatile and non-volatile media, removable and non-removable media. The system memory may include computer readable media in the form of volatile memory, such as random access memory (RAM); and/or non-volatile memory, such as read only memory (ROM) or flash RAM. It is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electric erasable programmable read-only memory (EEPROM), and the like, can also be utilized to implement the example computing system and environment.

Reference has been made throughout this specification to “an example,”“alternative examples,” “at least one example,” “an implementation,” or “an example implementation” meaning that a particular described feature, structure, or characteristic is included in at least one implementation of the present invention. Thus, usage of such phrases may refer to more than just one implementation. Furthermore, the described features, structures, or characteristics may be combined in any suitable manner in one or more implementations.

One skilled in the relevant art may recognize, however, that code module initialization may be implemented without one or more of the specific details, or with other methods, resources, materials, etc. In other instances, well known structures, resources, or operations have not been shown or described in detail merely to avoid obscuring aspects of the invention.

While example implementations and applications of the code module initialization have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the invention, as both described above and claimed below.

We claim:

1. A method, comprising:
listing dependencies among plural modules;
initializing a first one of the plural modules in plural isolated execution constructs in a managed execution environment; and
initializing at least a second one of the plural modules having a listed dependency from the first one of the plural modules in each of the plural isolated execution constructs.

2. A method according to claim 1, further comprising:
updating the listed dependencies; and
constraining all isolated execution constructs in the managed execution environment to the listed dependencies.

3. A method according to claim 1, further comprising:
updating the listed dependencies; and
initializing, in each isolated execution construct in the managed execution environment in which the first one of the plural modules is initialized, each one of the plural modules that has a listed dependency from the first one of the plural modules.

4. A method according to claim 1, wherein the listing includes graphing all code among the plural modules at compile time for at least one of the isolated execution constructs.

5. A method according to claim 1, wherein the listing includes graphing all code for the first one of the plural modules to call code in at least the second one of the plural modules.

6. A method according to claim 1, wherein the listing includes graphing all code for the first one of the plural modules to access a static or global method in at least the second one of the plural modules.

7. A method according to claim 1, wherein the listing includes graphing all code for the first one of the plural modules to allocate an instance of a type in at least the second one of the plural modules.

8. A method according to claim 1, wherein the listing includes graphing all code for the first one of the plural modules to call a generic method with a type parameter from at least the second one of the plural modules.

9. A method according to claim 1, wherein:
the initializing of the first one of the plural modules includes activating the first one of the plural modules by running initialization code for the module, and the initializing of at least the second one of the plural modules includes activating at least the second one of the plural modules by running initialization code for the module.

10. At least one computer-readable medium having one or more instructions that, when read, cause one or more processors to:
compile code for plural modules in at least one of plural application domains;
graph active relationships among the plural modules from the compiled code;
initialize a first one of the plural modules; and
enforce a constraint on at least a second one of the plural modules, for which an active relationship with the first module is graphed, in any one of the plural application domains that the first module is initialized.

11. At least one computer-readable medium according to claim 10, wherein the one or more instructions to derive active relationships among the plural modules from the compiled code cause the one or more processors to detect that at least a portion of code corresponding to at least the second one of the plural modules is actively dependent upon at least a portion of code corresponding to the first one of the plural modules.

12. At least one computer-readable medium according to claim 10, wherein the one or more instructions to derive active relationships among the plural modules from the compiled code cause the one or more processors to detect that code from corresponding to the first one of the plural modules is to access a static or global field of a type declared in at least the second module.

13. At least one computer-readable medium according to claim 10, wherein the one or more instructions to graph active relationships among the plural modules from the compiled code cause the one or more processors to detect that code from corresponding to the first one of the plural modules is to allocate an instance of a type derived from a portion of at least the second module.

14. At least one computer-readable medium according to claim 10, wherein the one or more instructions to graph active relationships among the plural modules from the compiled code cause the one or more processors to detect that code from corresponding to the first one of the plural modules is to call a generic method with a type parameter derived from a portion of at least the second module.

15. At least one computer-readable medium according to claim 10, wherein the one or more instructions to enforce the constraint further cause the one or more processors to enforce the constraint when the derived active relationships among the plural modules are refreshed.

16. At least one computer-readable medium according to claim 10, wherein the one or more instructions to enforce the constraint cause the one or more processors to initialize at least the second module in any one of the plural application domains that the first module is initialized.

17. A system, comprising:
a loader to load modules of code into a runtime environment;
a compiler to list active dependencies existing among the modules of code;
an executor to initialize a first module of code in at least one isolation construct and to further initialize, in the at least one isolation construct, any other of the modules of code having an active dependency from the first module of code.

18. A system according to claim 17, wherein the compiler is to determine that a portion of code in the first module in-lines a non-virtual method in at least the second module.

19. A system according to claim 17, wherein the compiler is to determine that a portion of code in the first module in-lines a static or global method in at least the second module.

20. A system according to claim 17, wherein the executor is to trigger a runtime check of the isolation constructs in which the executor is to initialize the other module of code, when the initialization of the first module of code fails in any of the isolation constructs.
